(19) United States
(12) Patent Application Publication
(10) Pub. No.: US 2009/0164928 A1
(43) Pub. Date: Jun. 25, 2009

(54) METHOD, APPARATUS AND COMPUTER PROGRAM PRODUCT FOR PROVIDING AN IMPROVED USER INTERFACE

(75) Inventors: Matthew Brown, London (GB); Udo Szabo, Helsinki (FI); Aapo Henrik Bovellan, Espoo (FI); Aki Antero Hussa, Liminka (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/962,301

(22) Filed: Dec. 21, 2007

(51) Int. Cl. G06F 3/048

(52) U.S. Cl. 715/767

(57) ABSTRACT

An apparatus for enabling improved access to content items such as media content and applications may include a processor. The processor may be configured to provide for presentation of one or more graphical elements on a first axis, each of the graphical elements corresponding to a particular media type, present one or more content items associated with a currently highlighted one of the graphical elements on a second axis, and enable a user to modify display features associated with at least one of the graphical elements.

### TECHNOLOGICAL FIELD

Embodiments of the present invention relate generally to content access technology and, more particularly, relate to a method, apparatus and computer program product for providing an improved user interface.

### BACKGROUND

The modem communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices with respect to managing, creating and consuming multimedia content. Due to the ubiquitous nature of mobile communication devices, people all over the world and of all walks of life are now utilizing mobile terminals to communicate with other individuals, entities or contacts and/or to share or consume information, media and other content. Additionally, given recent advances in processing power, battery life, memory and the availability of peripherals such as video/audio recording and playback, mobile terminals are becoming prolific producers and consumers of media. As mobile electronic device capabilities expand, a corresponding increase in the storage capacity of such devices has allowed users to store very large amounts of content on the devices. Given that the devices will tend to increase in their capacity to store content, and given also that mobile electronic devices such as mobile phones often face limitations in display size, text input speed, and physical embodiments of user interfaces (UI), challenges are created in content management. Specifically, an imbalance between the development of stored content capabilities and the development of physical UI capabilities may be perceived.

In order to provide a solution for the imbalance described above, it may be desirable to provide an improved mechanism by which mobile terminal users may access content.

### BRIEF SUMMARY

A method, apparatus and computer program product are therefore provided to enable improved access to content items such as media content and applications. In particular, a method, apparatus and computer program product are provided that may enable improved access to content and applications of various different types by providing a plurality of graphical elements or tiles, each of which, in one exemplary embodiment, may be associated with a different media type or subject matter. Content items associated with a currently highlighted one of the graphical elements or tiles may simultaneously be provided for browsing or selection by a user. Such content items may be any kind of content including, for example, phone book entries, contacts, instant messaging presence, online status, media content, files, documents, and/or the like. Embodiments of the present invention may therefore provide improved or easier access to applications, media content, content or items unrelated to media, and/or other information by providing a general framework for navigation through content of various different types. As a result, for example, mobile terminal users may enjoy an improved content management capability and a corresponding improved ability to access and experience content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for enabling an improved content management capability according to an exemplary embodiment of the present invention;

FIG. 4 illustrates an example of a graphical user interface for a navigational interface structure in a normal operating mode according to an exemplary embodiment of the present invention;

FIG. 5 illustrates another mode of operation of the navigational interface structure according to an exemplary embodiment of the present invention;

FIG. 6 illustrates yet another mode of operation of the navigational interface structure according to an exemplary embodiment of the present invention;

FIG. 7 illustrates still another mode of operation of the navigational interface structure according to an exemplary embodiment of the present invention; and

FIG. 8 is a flowchart according to an exemplary method for enabling an improved content management capability according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

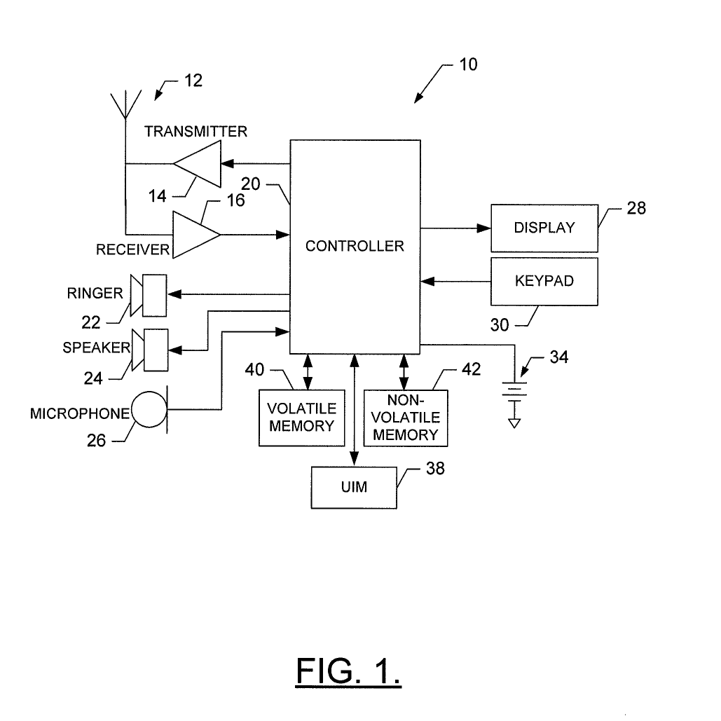

FIG. 1, one aspect of the invention, illustrates a block diagram of a mobile terminal 10 that may benefit from embodiments of the present invention. It should be understood, however, that a mobile telephone as illustrated and hereinafter described is merely illustrative of one type of electronic device that may benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, tablets, internet capable devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It should be understood that the apparatus such as the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick, scrolling device or other user input interface. The mobile terminal 10 may further include a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 may additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

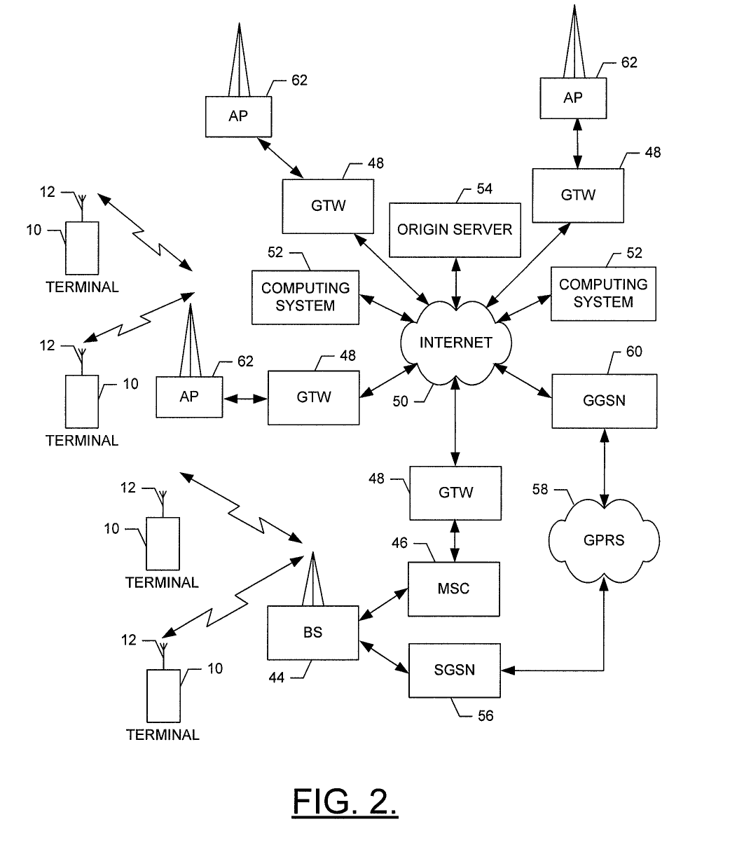

FIG. 2 is a schematic block diagram of a wireless communications system according to an exemplary embodiment of the present invention. Referring now to FIG. 2, an illustration of one type of system that may benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 may be capable of routing calls to and from the mobile terminal 10 when the mobile terminal 10 is making and receiving calls. The MSC 46 may also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) may be coupled to the mobile terminal 10 via the Internet 50. For example, as explained below, the processing elements may include one or more processing elements associated with a computing system 52 (two shown in FIG. 2), origin server 54 (one shown in FIG. 2) or the like, as described below.

The BS 44 may also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, may be coupled to a data network, such as the Internet 50. The SGSN 56 may be directly coupled to the data network. In a more typical embodiment, however, the SGSN 56 may be coupled to a packet-switched core network, such as a GPRS core network 58. The packet-switched core network may then be coupled to another GTW 48, such as a gateway GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 may further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, Bluetooth™ (BT) brand wireless technology developed by the Bluetooth™ Special Interest Group, Wibree™ radio standards, Wi-Fi, ultra wideband (UWB) and/or the like. The APs 62 may be coupled to the Internet 50. Like with the MSC 46, the APs 62 may be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 may additionally, or alternatively, include a removable memory capable of storing content, which may thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content acquisition or sharing) between the mobile terminal 10 and other mobile terminals or network devices. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

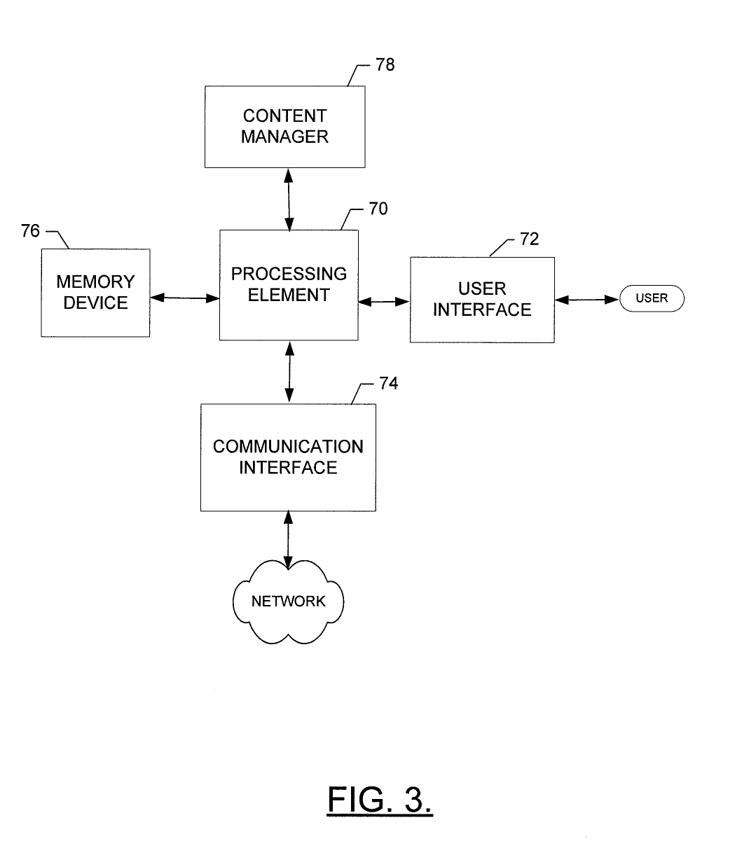

An exemplary embodiment of the invention will now be described with reference to FIG. 3, in which certain elements of a system for enabling access to media content via an improved user interface are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. As an example of devices other than the mobile terminal of FIG. 1, the system of FIG. 3 may be employed on a personal computer, a camera, a video recorder, a handheld computer, a server, a proxy, etc. Alternatively, embodiments may be employed on a combination of devices including, for example, those listed above. For example, a user interface of a client device according to embodiments of the present invention may enable the client device to access content stored at a serving device. It should also be noted that while FIG. 3 illustrates one example of a configuration of a system for enabling access to media content via an improved user interface, for example, in a mobile environment, numerous other configurations may also be used to implement embodiments of the present invention. As such, it should be noted that the devices or elements described below may not be mandatory and thus some may be omitted in certain embodiments.

Referring now to FIG. 3, an apparatus for enabling access to media content via an improved user interface is provided. The apparatus may include a combination of entities or devices that may be embodied in hardware, software or a combination of hardware and software for use in connection with embodiments of the present invention. Although an embodiment will be described below in the context of certain media types, other types of media may also be utilized in accordance with embodiments of the present invention.

In one example, embodiments of the present invention may be practiced by the apparatus embodied as a device such as the mobile terminal 10. In this regard, the apparatus may include or otherwise be in communication with a processing element 70 (e.g., controller 20), a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, content, data, applications, instructions or the like for enabling the apparatus to carry out various functions in accordance with exemplary embodiments of the present invention. For example, the memory device 76 could be configured to buffer input data for processing by the processing element 70. Additionally or alternatively, the memory device 76 could be configured to store instructions for execution by the processing element 70. As yet another alternative, the memory device 76 may be a database that stores information and/or media content. In an exemplary embodiment, different types of content items may be stored in separate folders or separate portions of the memory device 76. However, content items of different types could also be commingled within the memory device 76 or within folders of the memory device 76. For example, one folder within the memory device 76 could include content items related to types of content such as music, broadcast content (e.g., from the Internet and/or radio stations), video/audio content, pictures, etc. Alternatively, separate folders may be dedicated to each type of content. For example, a music library may be designated to receive content items associated with song tracks.

The processing element 70 may be embodied in a number of different ways. For example, the processing element 70 may be embodied as a processor, a coprocessor, a controller or various other processing means or devices including integrated circuits such as, for example, an ASIC (application specific integrated circuit) or an FPGA (field programmable gate array). In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network and/or a wired connection interface (e.g., modem, USB connection, etc.) and supporting hardware and/or software for enabling wired communications with a network.

The user interface 72 may be in communication with the processing element 70 to receive an indication of a user input at the user interface 72 and/or to provide an audible, visual, mechanical or other output to the user. As such, the user interface 72 may include, for example, a keyboard, a mouse, a joystick, a scrolling device, a touch screen display, a conventional display, a microphone, a speaker, or other input/output mechanisms. In an exemplary embodiment in which the apparatus is embodied as a server, the user interface 72 may be limited, or eliminated. However, in an embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30.

In an exemplary embodiment, the processing element 70 may be embodied as or otherwise control a content manager 78. The content manager 78 may be any means such as a device or circuitry embodied in hardware, software or a combination of hardware and software that is configured to perform the corresponding functions of the content manager 78 as described in greater detail below. In this regard, for example, the content manager 78 may be configured to generate a navigational interface structure for display via the user interface 72. The navigational interface structure may be utilized, for example, (e.g., via inputs received from the user and outputs provided to the user by the user interface 72) to navigate or browse various types of content and or applications in order to enable selection of a particular content item or application for rendering or execution. Accordingly, in an exemplary embodiment, a user may utilize the user interface 72 to initiate a selection of information or content via the navigational interface structure. The information or content selected may then be rendered via the user interface 72.

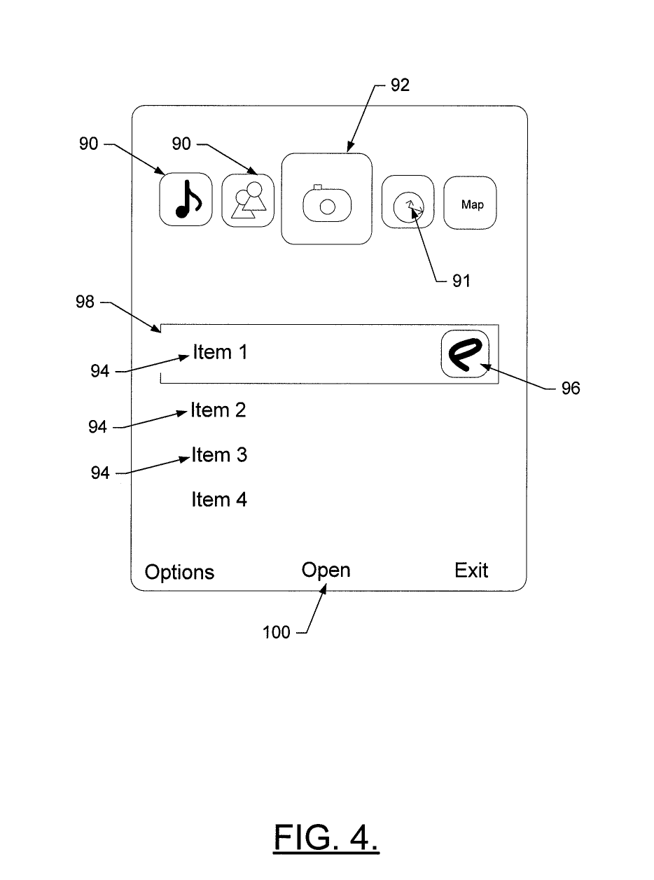

In an exemplary embodiment, the content manager 78 may be configured to provide a plurality of graphical elements (referred to hereinafter as tiles) (e.g., see element 90 of FIG. 4) on a first axis such as, for example, on a horizontal axis and corresponding content items associated with a currently highlighted one of the tiles on a second axis such as, for example, a vertical axis. The content manager 78 may be further configured to enable the user to modify display properties or features associated with the tiles. For example, the user may be able to modify a characteristic of the tiles (e.g., in appearance or with respect to other features associated with tile rendering), the ordering of the tiles, which (or how many) tiles are presented at any given time and various other features associated with presentation of the tiles. Similarly, the content manager 78 may enable the user to modify the content items (e.g., in appearance or with respect to other features associated with content item rendering), the ordering of the content items, which (or how many) content items are presented at any given time and various other features associated with presentation of the content items. Content items, which may correspond to particular information, media content or applications, may be browsed and/or selected via the user interface 72 and, in response to selection of information, media content or an application, the selected information, media content or application may be rendered or executed, for example, by the processing element 70 via the user interface 72.

The tiles may be embodied as, or include, an icon that may be associated with a particular type of media content or data. In some instances, the tile may be directly associated with the particular type of media content or data associated therewith. For example, a tile associated with music may be represented by an icon including a musical note or other indicia commonly associated with music. Meanwhile, a tile including a camera icon may be associated with pictures, a tile associated with video may include an icon displaying a movie tape reel, a projector or some other indicia commonly associated with video or movies and documents may be associated with a tile having indicia of a sheet of paper. Other types of media content or data (e.g., contacts, phonebook, map or routing services, internet applications, etc.) may also have a corresponding icon or other indicia associated with their respective tiles in order to identify the type of media content or data associated with each tile to the user upon inspection. Alternatively, the icons or indicia associated with some or all of the tiles may be randomly assigned, text based, or even determined by the user. For example, the indicia associated with a tile (e.g., the icon) may be user selected or created animation, text, graphics, or even a picture captured or obtained by the user. As an alternative the icons or indicia associated with the tiles may be predetermined or the user may download content to be associated with each tile.

One or more of the tiles may also include one or more dynamic elements. Accordingly, the tiles may be embodied as dynamic link icons. In this regard, for example, a dynamic element may be a sub-icon or a portion of the tile that includes characteristics that change with corresponding application state changes. As such, for example, if the tile relates to a scheduling application that includes an icon or indicia of a clock, the dynamic element may provide that hands of the clock correspond to the current time, that the current date is displayed, or that an indication is provided if there is an alarm set or an event scheduled. Such dynamic elements may also be employed in association with icons that may be associated with content items themselves.

FIGS. 4-7 illustrate examples of a graphical user interface that may be employed according to various exemplary embodiments. In this regard, FIG. 4 illustrates an exemplary display showing the navigational interface structure of an embodiment of the present invention. The navigational interface structure of embodiments of the present invention may be presented, for example, in an active idle state. As shown in FIG. 4, the navigational interface structure includes tiles 90 that are presented along the horizontal axis near the top of the display. However, it should be appreciated that the tiles 90 could alternatively be displayed near the bottom or even in the middle portion of the display. The manner in which the navigational interface structure is presented and manipulated may be controlled by the processing element 70 (e.g., via the content manager 78). Each of the tiles 90 may include an icon as described above and at least one of the icons may include a dynamic element 91. In the example of FIG. 4, the dynamic element 91 is representative of the current time for a calendar application. The remaining tiles 90 each include indicia or an icon indicative of the corresponding type of media content or data associated therewith.

When a particular tile is opened, the particular tile may be considered an opened tile 92. Content items 94 associated with the opened tile 92 may then be displayed, for example, along the vertical axis. Each of the content items, when displayed, may include information descriptive of the content item and/or an icon 96 or graphical representation of or associated with the content item. For example, if the content item is an image or series of images, one or more thumbnails may be associated with the content item. If the content item is a song, information indicating the artist, track length, album, release date, etc., may be associated with the content item and the icon 96 could be, for example, an album cover, a picture of the artist, etc. If the content item is contact information for a particular contact, the address, email address, phone number, or other information associated with enabling communication with a particular contact may be provided and the icon 96 may be a picture of the contact or may be indicative of the type of contact information available. In some instances, selection of a particular content item and/or icon may trigger the performance of a function such as contacting the associated contact, executing a corresponding application, rendering corresponding media, etc.

The opening of a tile may be accomplished in different ways. In some instances, each of the tiles 90 may be associated with a corresponding key of a keyboard. In this regard, the content manager 78 may store, based on user input, key associations for each of the tiles. For example, if there are eight tiles, each tile may be associated with a corresponding number one through eight on the keyboard. Accordingly, if the key “5” is selected, the tile associated with the key “5” may be opened. As an alternative, the tiles 90 may be scrolled over to highlight one tile at a time. A separate function key may be selected in order to open the highlighted tile. For example, a particular soft key may be designated for opening of a highlighted tile. As yet another alternative, the highlighted tile may automatically be opened or may be opened by voice activation. In some embodiments, a highlight window may be presented that may shift over the highlighted tile. Alternatively or additionally, the highlighted tile may be distinguished in some other way. For example, the highlighted tile may be made larger or smaller, moved to a central (or other specified) location among the tiles 90, be colored or have a colored border or other indicia applied thereto, and/or the like. The opened tile 92 may be distinguished from other tiles 90 in various different ways. For example, any of the mechanisms described above for identifying a highlighted tile may be used to indicate the opened tile 92. As such, the opened tile 92 of FIG. 4 could also represent a highlighted tile.

Once a particular one of the tiles 90 is selected as the opened tile 92 and the corresponding content items 94 are displayed, the content items themselves may be browsed over and/or selected. In this regard, for example, a highlight window 98 may be provided to indicate which one of the content items 94 (or tiles, if used in connection with highlighting a tile) is currently highlighted. Once a content item is selected, the corresponding content may be presented or a corresponding application may be launched. As such, a playlist associated with a content item may be played, a video may be played, a picture may be displayed, a picture album may be opened, a contact may be called, an address may be mapped, an internet site may be accessed, or various other functions associated with content items may be executed by selection of the corresponding highlighted content item. Of note, each content item may have one or more actions linked therewith or accessible therefrom. As indicated above with respect to opened or highlighted tile differentiation, the currently highlighted content item may be differentiated from others of the content items 94 in various ways that may be similar to those described above. In this regard, for example, since some content items may represent items that, when selected, may launch or open a corresponding application or program or access a corresponding file, while other content items may represent content that is currently being rendered, differentiation of content items by highlighting with color, size, a distinctive border or frame, etc., may be desired. In an exemplary embodiment, a soft key 100 may be provided for selection of the currently highlighted content item. However, the currently highlighted content item may alternatively be selected by another mechanism, such as by selection of the currently highlighted content item using a hard key like a scroller (e.g., a navigation wheel) or by selection with a voice command, a touch or mouse click, etc.

In an exemplary embodiment, as tiles or content items are highlighted, the highlighted tile or content item may move to a predefined location (e.g., centrally or prominently (such as being first in a list) located). In some embodiments, for example, after the last tile is encountered in a sequence of the tiles, another function may be performed. For example, after the last tile is encountered, the content items 94 may be accessible. Alternatively, for example, if a particular tile (e.g., being oriented on the horizontal axis) is selected and the user presses a predefined key (e.g., up or down), then another list other than the content items 94 may be encountered (e.g., a listing of modes, settings, files, applications or other menu options, etc.).

The content manager 78 may specify the number of tiles that may be in use. Thus, for example, a limit may be applied to the number of tiles that may be utilized at any given time. However, in some embodiments, there may be no limit to the number of tiles in use. In either case, it may be desirable to limit the number of active tiles (e.g., the number of tiles that can be displayed or accessed normally by scrolling or direct access via a single key selection) even though other tiles (e.g., inactive or hidden tiles) may be usable but currently hidden. The active tiles may define a tile rotation (or graphical element rotation) in which one tile may be considered a default tile (e.g., the tile that is highlighted when the apparatus is initially powered up) and other tiles may have a particular sequence that extends from the default tile through each other tile until a last tile of the sequence is encountered. After the last tile is encountered, continued scrolling may cause the default tile to be encountered again so that the sequence may be repeated. The content manager 78 may therefore enable the selection of which tiles are to be designated as active tiles. In some embodiments, the normal display mode associated with the navigational interface structure may include an options menu or other mode changing function to enable shifting from the normal display mode (e.g., as illustrated in FIG. 4) to another mode of operation. The options menu may be accessible via a soft key function or any other suitable mechanism.

In one embodiment, the normal display mode illustrated in FIG. 4 could be modified. For example, if opening of a highlighted tile is required to provide for the display of the corresponding content items 94, the display may initially only show the tiles 90, without any content items 94. Then, after opening the opened tile 92, the content items 94 that are associated with the opened tile 92 may be displayed. In another embodiment, the display may only show the tiles 90. In such a situation, the axis upon which the tiles 90 are displayed (e.g., the horizontal tile bar) may be moved (e.g., downward or upward). Moreover, the horizontal tile bar may be moved regardless of whether or not the vertical bar (e.g., the bar indicating the content items) is closed or otherwise invisible. As such, the content items in the vertical bar, if displayed, may automatically be shifted to accommodate a repositioning of the horizontal bar. The normal display mode of the navigational interface structure of embodiments of the present invention may be accessible via the launching of a corresponding application associated with the navigational interface structure (e.g., via selection of a link, icon, etc.). Alternatively, certain predefined functions or conditions may trigger opening of the navigational interface structure of embodiments of the present invention.

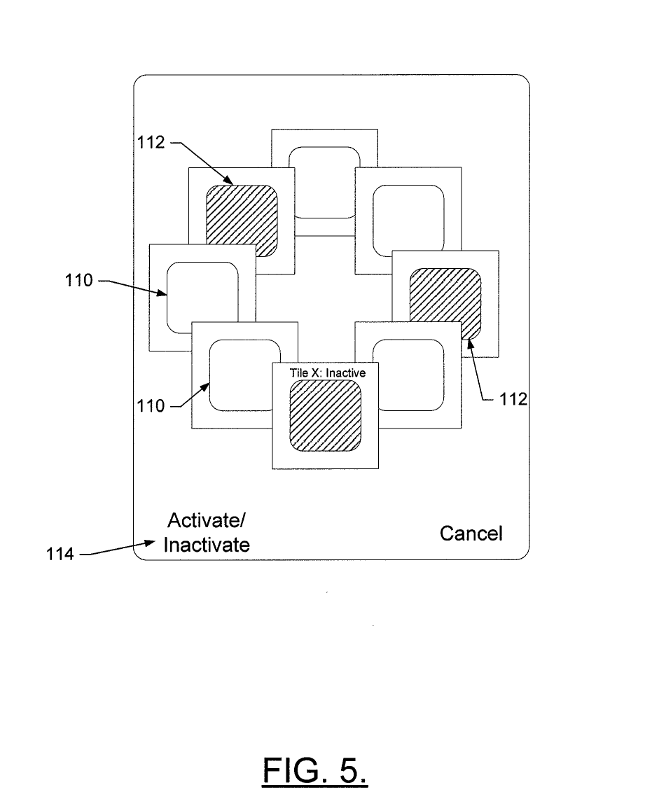

FIG. 5 illustrates another mode of operation of the navigational interface structure according to an exemplary embodiment of the present invention. In this regard, FIG. 5 illustrates a hide mode which may be utilized to define which tiles are active tiles. As shown in FIG. 5, when in the hide mode, every available tile may be displayed. In this example the available tiles are displayed in a ring formation, but other display formats (e.g., a list or grid format) could alternatively be used. As indicated in FIG. 5, each of the tiles may include indicia of whether the tile is currently selected as an active tile 110 (e.g., a tile that is displayed in the tile rotation in the normal display mode) or an inactive tile 112 (e.g., a tile that may have associated content items, but which is not displayed in the tile rotation in the normal display mode). In the example of FIG. 5, inactive tiles are distinguished by cross hatching for exemplary purposes only. However, numerous other mechanisms may be used to distinguish between active and inactive tiles. For example, active and inactive tiles may be distinguished by text entry, an icon, coloration, size, distinctive borders, or other like mechanisms. In some embodiments, each of the tiles may be scrolled over and an option corresponding to changing the current tile state may be provided for selection by, for example, execution of a corresponding soft key function 114. In an exemplary embodiment, all tiles may be initially active tiles by default and each tile may be selectable for hiding tiles down to a minimum number of one active tile. Accordingly, for example, once only one tile is active, the functionality for hiding or rendering the last active tile inactive may be removed.

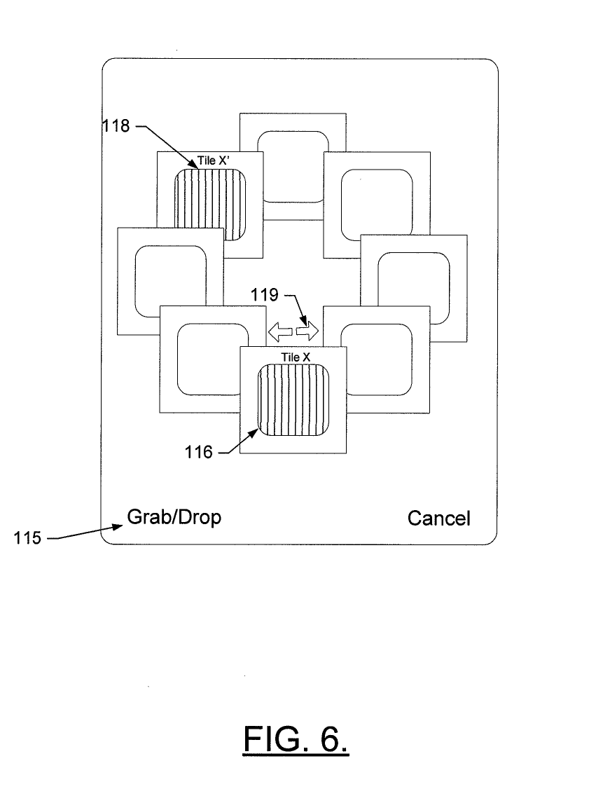

In an exemplary embodiment, the content manager 78 may also enable the movement of tiles within the tile rotation in another mode of operation (e.g., a move mode). For example, in reference to FIG. 6, when in the move mode, any particular tile could be grabbed and moved to another location within the tile rotation (e.g., via a drag-and-drop operation). Thus, for example, when a particular tile is grabbed, an indicator may slide between other tiles of the tile rotation to indicate the new location of the grabbed tile if the tile were dropped at the present location. As another alternative, when in the move mode, a particular tile may be selected and a key may be utilized to shift the tile one spot in a predefined direction associated with the key. Thus, subsequent presses of the key will result in movement of the particular tile past a corresponding number of other tiles in the tile rotation. Entry into the move mode may be accomplished via the options menu and exiting from the move mode may be made again by a menu selection or by selection of a predefined key or soft key.

As shown in FIG. 6 by way of example, a particular soft key having a corresponding soft key function 115 may be associated with operations of grabbing and/or dropping particular tiles. Thus, a particular tile (e.g., tile X 116) may initially be grabbed using the soft key function 115 and moved (e.g., using a scroller, finger or mouse) to be dropped (again using the soft key function 115) at a different location (e.g., as indicated by the position of tile X′ 118). A predefined direction for shifting the tile or a directional option indicator 119 may also be provided.

As indicated above, the content manager 78 may also enable the assignment of particular keys to corresponding tiles to enable single key access to opening a particular tile. This functionality may also be accessed, for example, via the options menu. Furthermore, the options menu may provide, for example, access to a listing of keys and their associated tiles and/or content items. Other functionality may also be accessed via the options menu. However, all of the functionality associated with the options menu could alternatively be provided via predefined key associations.

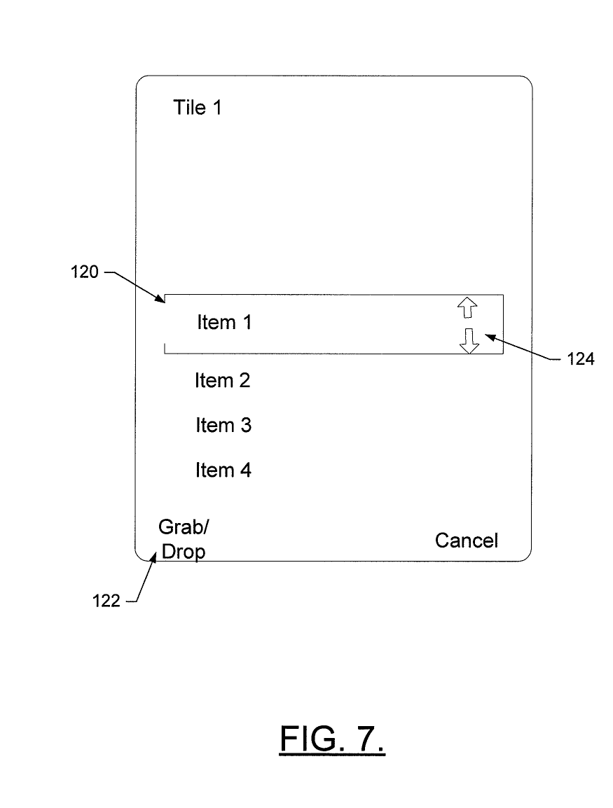

As another example of features that may be associated with embodiments of the present invention, an edit mode may be provided for altering features associated with the content items 94. FIG. 7 illustrates an example of the edit mode in which the order of entries or content items associated with a particular tile may be altered. As shown in FIG. 7, when in the edit mode, the tile associated with the edit operation may be identified. The content items associated with the identified tile may then be displayed in a particular order. A highlighted content item 120 may be selected for movement within the ordering of content items presented (e.g., content item rotation). Similar to the manner described above with respect to movement of tiles, movement of a content item selected may be accomplished by a drag-and-drop type operation or by selecting the content item and then executing a shift function to shift the content item iteratively in a predefined direction. The grab/drop key function 122 is indicative of a key function that may be utilized for the function described above. The arrow icons 124 are indicative of directional movement options that may be employed for a selected content item to execute movement of the selected content item within the content item rotation in the corresponding direction.

Other functions may also be performed with respect to a given content item in the edit mode. For example, content items may be deleted or modified (e.g., the icon 96 may be changed, text associated with identifying the content item may be altered, display properties may be altered, etc.). However, in some embodiments, the icon 96 may not be displayed in the edit mode. Additionally, similar to the treatment available for tiles, each content item associated with a particular tile may be further associated with a particular key (e.g., a keyboard number or letter) to enable single key access to a corresponding content item without any need for execution of a scroll function or other search operation.

Additionally or alternatively, the content manager 78 may specify how many tiles can be displayed at any given time. For example, of the active tiles in the tile rotation, only a predetermined number may be visible on the display at any one time. FIG. 4 illustrates four tiles displayed at one time. However, there may be other active tiles that do not fit on the display, but which may be encountered by scrolling or browsing through the tile rotation. Similarly, a predefined maximum number of content items may be displayed in association with an opened tile as determined by the content manager 78. In either case, the user may be enabled to provide settings or a profile to form the basis for determining what maximum number of tiles and/or content items can be displayed at any given time. The maximum number of tiles and/or content items may then be displayed within the context of the corresponding tile or content item rotation. In other words, for example, if there are a total of eight content items associated with a particular tile but the maximum number of content items that can be displayed is four, then four content items will initially be displayed (e.g., with the initial content item being a default first content item) and the remaining four content items may be encountered sequentially with the execution of four subsequent scroll operations in one direction. Further scroll operations would then repeat content items within the content item rotation. As an alternative, the content manager 78 may provide a size to fit option in which all tiles and/or content items may be sized and/or ordered in such a manner as to permit the display of all active tiles or content items.

Given the ability to utilize the content manager 78 for manipulating the tiles 90 and/or content items 94, and manipulating display properties thereof, a user may enjoy an ability to have relatively highly customizable access to media and other information or applications with a relatively direct capability for such access. Thus, for example, the navigational interface structure of embodiments of the present invention provides users with the ability to make their most important content easier for them to access. In this regard, embodiments of the present invention provide an adaptive, content first menu structure in which content items may be easily browsed and selected and corresponding applications may be launched as needed to support rendering of selected content items. Thus, embodiments of the present invention may provide for the ability to access content without first finding a corresponding application with which the content may be associated.

It should be noted that although an embodiment of the present invention has been described above in the context of tiles laid out over a linear axis, alternative embodiments may provide a curved or even circular axis. Thus, for example, the tiles could be presented in a “carousel” fashion in some embodiments. Moreover, in some embodiments the user may be enabled to select either the carousel structure or the X/Y structure (or T-bone) further described above. In this regard, for example, a transition between structures may be accomplished via selection of a menu option, selection of a predefined key, selection of a particular function under predefined circumstances (e.g., pressing a key input defining a direction other than the direction of navigation within the structure such as pressing up from the horizontal orientation of the tiles), etc. In some embodiments, the transition from T-bone to carousel structure may be graphically illustrated. For example, the T-bone structure could “morph” into the carousel structure (or vice versa) by graphically bending the horizontal axis presented in the T-bone structure until the ends meet to form a ring. In an exemplary embodiment, the ring may be bent upward so that the prior ends of the T-bone structure meet at the top of the newly constructed ring. In some embodiments, the tiles may be presented in a gradually reducing size as the tiles move closer to the top of the ring to provide an illusion of distance of the tiles at the top of the ring and make those tiles at the bottom of the ring appear closer. The tile at the very bottom of the ring may appear largest to thereby indicate that it is the selected tile. The ring could alternatively be formed by bending the ends down rather than up and tiles at the top could be made to appear closer than those at the bottom. Furthermore, a three dimensional (3-D) structure may be employed in connection with any of the embodiments provided herein.

Furthermore, in some embodiments, different structures may be associated with different features or feature subsets. For example, in T-bone structure the tiles may represent feature X with subset Y, while in the carousel structure, the tiles may represent feature X with subset Z. Alternatively, in T-bone structure the tiles may represent feature X, while in the carousel structure, the tiles may represent feature Y. Accordingly, the different structures may be used for different purposes so that one structure is used for a first function (e.g. managing content) while the other structure is used for a second function (e.g. applications).

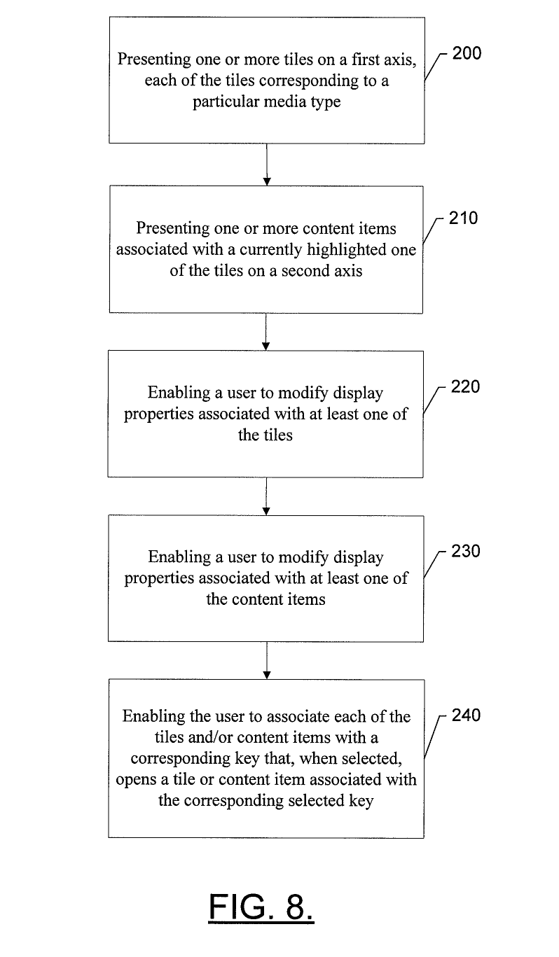

FIG. 8 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for enabling improved access to content items such as media content and applications as illustrated, for example, in FIG. 8 may include providing for presentation of one or more graphical elements or tiles at operation 200. In an exemplary embodiment, the tiles may be presented on a first axis (e.g., a horizontal axis) and each of the tiles may correspond to a respective particular media type. However, it is not necessary that each tile correspond to a respective particular media type. At operation 210, one or more content items associated with a currently highlighted one of the tiles may be provided for presentation on a second axis (e.g., a vertical axis). Embodiments of the present invention may further enable a user to modify display properties associated with at least one of the tiles at operation 220. In some embodiments, the user may be further enabled to modify display features or properties (e.g., a subset of features) associated with at least one of the content items at operation 230. Other optional operations may also be included in the method such as, for example, enabling the user to associate each of the tiles and/or content items with a corresponding key that, when selected, opens a tile or content item associated with the corresponding selected key at operation 240.

In an exemplary embodiment, operation 200 may include enabling the user to modify an appearance characteristic of at least one of the tiles or enabling the user to modify an order of the tiles within a tile rotation. Modification to the order of the tiles may be accomplished by a drag-and-drop operation or by selecting a tile for movement and then sequentially shifting the selected tile through the tile rotation with repeated further commands. In one embodiment, operation 200 may include enabling the user to modify a number of tiles that may be included in a tile rotation defining an order of the tiles. In this regard, the modification of the number of tiles in the tile rotation may be accomplished by assigning each tile with an active or inactive designation in which only active tiles are included in the tile rotation.

In an exemplary embodiment, operation 230 may include enabling the user to modify a content item rotation defining an order of the content items. The content item rotation may be modified in a manner similar to that described above for the modification of the tile rotation. In some embodiments, the tiles and/or the content items may include a dynamic element. Additionally, or alternatively, the currently highlighted one of the tiles may be differentiated from the other tiles on the basis of display properties associated with the currently highlighted one of the tiles.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
providing for presentation of one or more graphical elements on a first axis;
providing for presentation of one or more content items associated with a currently highlighted one of the graphical elements on a second axis; and
enabling a user to modify display features associated with at least one of the graphical elements.

2. A method according to claim 1, wherein enabling the user to modify display features comprises enabling the user to modify an appearance characteristic of at least one of the graphical elements.

3. A method according to claim 1, wherein enabling the user to modify display features comprises enabling the user to modify an order of the graphical elements within a graphical element rotation.

4. A method according to claim 1, wherein enabling the user to modify display features comprises enabling the user to modify a number of graphical elements that may be included in a graphical element rotation defining an order of the graphical elements.

5. A method according to claim 1, further comprising enabling the user to modify display features associated with at least one of the content items.

6. A method according to claim 5, wherein enabling the user to modify display features associated with at least one of the content items comprises enabling the user to modify a content item rotation defining an order of the content items.

7. A method according to claim 5, further comprising enabling the user to associate each of the content items with a corresponding key that, when selected, opens a content item associated with the corresponding selected key.

8. A method according to claim 1, wherein providing for presentation of one or more graphical elements on the first axis comprises presenting the graphical elements on a horizontal axis.

9. A method according to claim 1, wherein providing for presentation of one or more content items on the second axis comprises presenting the graphical elements on a vertical axis.

10. A method according to claim 1, further comprising displaying a dynamic element associated with at least one of the graphical elements.

11. A method according to claim 1, further comprising enabling the user to associate each of the graphical elements with a corresponding key that, when selected, opens a graphical element associated with the corresponding selected key.

12. A method according to claim 1, further comprising differentiating the currently highlighted one of the graphical elements from the other graphical elements on the basis of display features associated with the currently highlighted one of the graphical elements.

13. A computer program product comprising at least one computer-readable storage medium having computer-readable program code portions stored therein, the computer-readable program code portions comprising:
a first executable portion for providing for presentation of one or more graphical elements on a first axis;
a second executable portion for providing for presentation of one or more content items associated with a currently highlighted one of the graphical elements on a second axis; and
a third executable portion for enabling a user to modify display features associated with at least one of the graphical elements.

14. A computer program product according to claim 13, wherein the third executable portion includes instructions for enabling the user to modify an appearance characteristic of at least one of the graphical elements.

15. A computer program product according to claim 13, wherein the third executable portion includes instructions for enabling the user to modify an order of the graphical elements within a graphical element rotation.

16. A computer program product according to claim 13, wherein the third executable portion includes instructions for enabling the user to modify a number of graphical elements that may be included in a graphical element rotation defining an order of the graphical elements.

17. A computer program product according to claim 13, further comprising a fourth executable portion for enabling the user to modify display features associated with at least one of the content items.

18. A computer program product according to claim 17, wherein the fourth executable portion includes instructions for enabling the user to modify a content item rotation defining an order of the content items.

19. A computer program product according to claim 17, further comprising a fifth executable portion for enabling the user to associate each of the content items with a corresponding key that, when selected, opens a content item associated with the corresponding selected key.

20. A computer program product according to claim 13, wherein the first executable portion includes instructions for presenting the graphical elements on a horizontal axis.

21. A computer program product according to claim 13, wherein the second executable portion includes instructions for presenting the graphical elements on a vertical axis.

22. A computer program product according to claim 13, further comprising a fourth executable portion for displaying a dynamic element associated with at least one of the graphical elements.

23. A computer program product according to claim 13, further comprising a fourth executable portion for enabling the user to associate each of the graphical elements with a corresponding key that, when selected, opens a graphical element associated with the corresponding selected key.

24. A computer program product according to claim 13, further comprising a fourth executable portion for differentiating the currently highlighted one of the graphical elements from the other graphical elements on the basis of display features associated with the currently highlighted one of the graphical elements.

25. An apparatus comprising a processor configured to:
provide for presentation of one or more graphical elements on a first axis, each of the graphical elements corresponding to a particular media type;
provide for presentation of one or more content items associated with a currently highlighted one of the graphical elements on a second axis; and
enable a user to modify display features associated with at least one of the graphical elements.

26. An apparatus according to claim 25, wherein the processor is further configured to enable the user to modify an appearance characteristic of at least one of the graphical elements.

27. An apparatus according to claim 25, wherein the processor is further configured to enable the user to modify an order of the graphical elements within a graphical element rotation.

28. An apparatus according to claim 25, wherein the processor is further configured to enable the user to modify a number of graphical elements that may be included in a graphical element rotation defining an order of the graphical elements.

29. An apparatus according to claim 25, wherein the processor is further configured to enable the user to modify display features associated with at least one of the content items.

30. An apparatus according to claim 29, wherein the processor is further configured to enable the user to modify a content item rotation defining an order of the content items.

31. An apparatus according to claim 29, wherein the processor is further configured to enable the user to associate each of the content items with a corresponding key that, when selected, opens a content item associated with the corresponding selected key.

32. An apparatus according to claim 25, wherein the processor is further configured to present the graphical elements on a horizontal axis.

33. An apparatus according to claim 25, wherein the processor is further configured to present the graphical elements on a vertical axis.

34. An apparatus according to claim 25, wherein the processor is further configured to display a dynamic element associated with at least one of the graphical elements.

35. An apparatus according to claim 25, wherein the processor is further configured to enable the user to associate each of the graphical elements with a corresponding key that, when selected, opens a graphical element associated with the corresponding selected key.

36. An apparatus according to claim 25, wherein the processor is further configured to differentiate the currently highlighted one of the graphical elements from the other graphical elements on the basis of display features associated with the currently highlighted one of the graphical elements.

37. An apparatus comprising:
means for providing for presentation of one or more graphical elements on a first axis, each of the graphical elements corresponding to a particular media type;
means for providing for presentation of one or more content items associated with a currently highlighted one of the graphical elements on a second axis; and
means for enabling a user to modify display features associated with at least one of the graphical elements.

38. A user interface comprising:
a display configured to provide for presentation of one or more graphical elements on a first axis, each of the graphical elements corresponding to a particular media type, wherein the display is also configured to provide for presentation of one or more content items associated with a currently highlighted one of the graphical elements on a second axis, and wherein the display is further configured to enable a user to modify display features associated with at least one of the graphical elements.
